(19) United States
(12) Patent Application Publication
(10) Pub. No.: US 2025/0307410 A1
(43) Pub. Date: Oct. 2, 2025

(54) FIRMWARE UPDATE METHOD FOR EMBEDDED DEVICE, EMBEDDED DEVICE, AND DEVELOPMENT END DEVICE

(71) Applicant: ESPRESSIF SYSTEMS (SHANGHAI) CO., LTD., Shanghai (CN)

(72) Inventors: Yuxin WANG, Shanghai (CN); Jiangang WU, Shanghai (CN); Chunguang XU, Shanghai (CN)

(21) Appl. No.: 18/864,256

(22) PCT Filed: Apr. 21, 2023
(86) PCT No.: PCT/CN2023/089849

§ 371 Date: Nov. 8, 2024

(30) Foreign Application Priority Data
May 9, 2022 (CN) 202210501784.0

(51) Int. Cl. G06F 21/57; G06F 21/64

(52) U.S. Cl. CPC G06F 21/572; G06F 21/575; G06F 21/64

(57) ABSTRACT

Disclosed in the present application are a firmware update method for an embedded device, an embedded device, a development end device, and a firmware update system for an embedded device. In response to that an update triggering module detects a triggering event for updating firmware of the embedded device, a data receiving module acquires transmission data from a source device, and writes update data for firmware update of the embedded device in the transmission data into a partition storing the transmission data. A data processing module processes the received update data according to update mode information in the transmission data to obtain new firmware data, and applies the new firmware data from a partition storing the new firmware data during the running of a bootloader program, so as to accomplish the firmware update.

### CROSS-REFERENCE TO RELATED APPLICATIONS

This application is the U.S. National Phase Application under 35 U.S.C. § 371 of International Patent Application No. PCT/CN2023/089849 filed on Apr. 21, 2023, which claims priority to CN patent application No. 202210501784.0 filed on May 9, 2022. The disclosures of the aforementioned applications are hereby incorporated by reference in their entireties.

### TECHNICAL FIELD

The present application relates to the field of embedded technology, and in particular to a firmware update method for an embedded device, an embedded device, a development end device, and a firmware update system for an embedded device.

### BACKGROUND ART

In the era of rapid development of Internet of Things (IoT) technology, a firmware over the air (FOTA) remote firmware update function is becoming one of the essential functions of IoT devices. By using the FOTA function, IoT devices can not only improve functionality and eliminate system vulnerabilities, but also provide differentiated services to different users, making products more popular in the market.

Traditional embedded devices, such as PCs or mobile phones, also have FOTA function integrated therein. Generally, PCs or mobile phones have CPUs with powerful computing power, as well as sufficient memory resources and physical storage space. However, the CPUs of IoT devices often have limited computing power, and memory resources as well as physical storage space thereof are also subject to many restrictions. In addition, PCs or mobile phones do not use FOTA frequently, usually updating once every few weeks. IoT devices perform FOTA more frequently, taking shared bicycles as an example, with an average of at least one update per week. This also puts higher requirements regarding the traffic consumption and time consumption of firmware updates. Excessive traffic consumption will cause huge expenses for operators; longer time consumption will also affect user experience.

In addition, there are many types of IoT devices with various functions, and the resources available for different models of devices are not the same. Even for devices of the same model, due to inconsistent software-defined functions, the software and hardware resources used for FOTA are also different, making it difficult to adopt a unified solution to simultaneously satisfy the implementation of FOTA function for a wide variety of IoT devices.

In view of this, providing a universal firmware update solution that can save traffic and time, can be deployed on devices with limited software and hardware resources, and can be applicable to a variety of usage scenarios and IoT devices with different functions is one of the technical problems to be solved urgently by those skilled in the art.

It is appreciated that the technical problems listed above are only examples and not limitations of the present application, and the present application is not limited to technical solutions that solve all of the above technical problems at the same time. The technical solution of the present application can be implemented to solve one or more of the above or other technical problems.

### SUMMARY OF THE INVENTION

To solve the above and other problems, the present application provides a firmware update method for an embedded device, which is applied to the embedded device, the embedded device includes a bootloader program and a firmware update acquisition program; the bootloader program is stored in a bootloader partition, and the firmware update acquisition program is stored in a corresponding firmware partition, wherein the firmware update acquisition program includes an update triggering module and a data receiving module, and the bootloader program includes a data processing module, and the method includes:
the update triggering module detects a triggering event for updating firmware of the embedded device;
the data receiving module acquires transmission data from a source device, the transmission data at least includes update data for firmware update of the embedded device and update mode information identifying the update mode adopted for the firmware this time; and writes the update data into a partition storing the transmission data; and
the data processing module processes the received update data according to the update mode information to obtain new firmware data, so as to apply the new firmware data from a partition storing the new firmware data during the running of the bootloader program.

Optionally, when the update mode information identifies that the update mode adopted for the firmware this time is differential update, the update data is patch data.

Optionally, the data processing module processing the received update data to obtain new firmware data includes:
performing differential decoding on the received patch data and the old firmware data to obtain new firmware data;
after the data processing module processing the received update data to obtain new firmware data, the method further comprises:
the data processing module writes the new firmware data into a partition storing the new firmware data, and sets the partition storing the new firmware data as a to-be-booted partition, so as to apply the new firmware data from the to-be-booted partition during the running of the bootloader program.

Optionally, before the data processing module performing differential decoding on the received patch data and the old firmware data to obtain new firmware data, the method further includes:
the data processing module acquires version verification information or digest verification information of the old firmware data from the transmission data, and determines whether the patch data matches the old firmware data according to the version verification information or the digest verification information; and
if yes, performing the operation of performing differential decoding on the received patch data and the old firmware data to obtain new firmware data.

Optionally, when the update mode information identifies that the update mode adopted for the firmware this time is compression update, the update data is compressed data.

Optionally, the data processing module processing the received update data to obtain new firmware data includes:
decompressing the compressed data to obtain new firmware data;
after the data processing module processing the received update data to obtain new firmware data, the method further comprises:
the data processing module writes the new firmware data into a partition storing the new firmware data, and sets the partition storing the new firmware data as a to-be-booted partition, so as to apply the new firmware data from the to-be-booted partition during the running of the bootloader program.

Optionally, when the update mode information identifies that the update mode adopted for the firmware this time is full update, the update data is new firmware data, and the partition storing the transmission data is the partition storing the new firmware data.

Optionally, the update triggering module detecting a triggering event for updating firmware of the embedded device includes:
the update triggering module receives a push message sent by the source device indicating that there is an updated version of the firmware; and
the update triggering module sends a query request to the source device as to whether there is an updated version of the firmware, and receives a reply message from the source device indicating that there is an updated version.

Optionally, after the data receiving module acquiring transmission data from a source device, the method further includes:
the data receiving module determines whether the received transmission data is encapsulated data; if yes, acquires update mode information from the transmission data to determine the update mode adopted for the firmware this time.

Optionally, before the data receiving module writing the update data into a partition storing the transmission data, the method further includes:
the data receiving module determines whether the update data has been encrypted; if yes, decrypts the update data according to encryption type information in the transmission data.

Optionally, before the data receiving module writing the update data into a partition storing the transmission data, the method further includes:
the data receiving module verifies whether the received update data is complete according to integrity verification parameter information in the transmission data.

Optionally, after the data receiving module writing the update data into a partition storing the transmission data, the method further includes:
the data receiving module sets the partition storing the transmission data as a to-be-booted partition, so that the data processing module acquires the transmission data from the partition storing the transmission data.

Optionally, before the data receiving module applying the new firmware data from a partition storing the new firmware data during the running of the bootloader program, the method further includes:
the data processing module acquires file header information from the transmission data, and verifies the file header information.

Optionally, before the data processing module applying the new firmware data from a partition storing the new firmware data during the running of the bootloader program, the method further includes:
the data processing module acquires signature information of update data from the transmission data, and verifies the signature information.

Optionally, after the data processing module applying the new firmware data from a partition storing the new firmware data during the running of the bootloader program, the method further includes:
the data processing module acquires integrity verification parameter information from the transmission data, and verifies whether the data written into the partition storing the new firmware data is complete.

Optionally, when the update mode information identifies that the update mode adopted for the firmware this time is differential update or compression update, after the data processing module acquiring integrity verification parameters from the transmission data and verifying whether the data written into the partition storing the new firmware data is complete, the method further includes:
if the integrity verification passes, the data processing module preforms the operation of setting the partition storing the new firmware data as a to-be-booted partition; if the integrity verification fails, the data processing module does not perform the operation of setting the partition storing the new firmware data as a to-be-booted partition.

The present application further provides an embedded device including: a first memory and a first processor, wherein the first memory is configured to store a computer program, and the first processor is configured to implement any of the above firmware update methods for an embedded device when executing the computer program.

The present application further provides a firmware update method for an embedded device, which is applied to a development end device, and the method includes:
determining an update mode adopted for firmware update and generating update mode information;
generating corresponding update data according to the update mode information; and
generating transmission data for firmware update of the embedded device based on the update data and the update mode information.

Optionally, the generating corresponding update data according to the update mode information includes:
when the update mode information is differential update, the generated update data is patch data;
when the update mode information is compression update, the generated update data is compressed data; and
when the update mode information is full update, the generated update data is new firmware data.

Optionally, the transmission data further includes any one or any combination of the following information:
file header information, signature information of update data, encryption type information for encrypting the update data, file format version information, version information of update data, verification information on whether the data has been encapsulated, compression algorithm information, differential update algorithm information, length information of update data, integrity verification parameter information, signature information, version verification information or digest verification information.

Optionally, after the generating transmission data for firmware update of the embedded device based on the update data and the update mode information, the method further includes:
sending the transmission data to a source device for storage.

The present application further provides a development end device including: a second memory and a second processor, the second memory is configured to store a computer program, and the second processor is configured to implement any of the above firmware update methods for an embedded device when executing the computer program.

The present application further provides a firmware update system for an embedded device including the above embedded device and a source device; and the source device stores transmission data for firmware update of the embedded device.

Optionally, the source device is a development end device or a cloud device.

For the firmware update method for an embedded device provided in the present application, the embedded device includes a bootloader program and a firmware update acquisition program; the bootloader program includes a data processing module, and the firmware update acquisition program includes an update triggering module and a data receiving module. In response to that the update triggering module detects a triggering event for updating firmware of the embedded device, the data receiving module acquires transmission data from a source device, and writes update data for firmware update of the embedded device in the transmission data into a partition storing the transmission data. The data processing module processes the received update data according to update mode information in the transmission data to obtain new firmware data, so as to apply the new firmware data from a partition storing the new firmware data during the running of the bootloader program to accomplish the firmware update.

In the present application, the data processing module is executed in the bootloader program in an optimized manner. Since the bootloader program does not need to load many operating system functions and does not need to have a protocol stack for network communication, the bootloader program has more available memory, which may provide more available memory space for the data processing module. For compression updates and differential updates, more available memory space means that higher-level compression algorithms may be used to perform compression, which results in smaller compressed packages or patch files, avoids excessive traffic consumption and time consumption, may be deployed on devices with limited software and hardware resources and improves the efficiency of firmware updates. In addition, compared with the existing solutions that can only support one firmware update method, the present application has better compatibility and can adopt different update methods to apply to different usage scenarios and IoT devices with different functions, and to satisfy different firmware update needs. In addition, the present application further provides an embedded device, a development end device, and a firmware update system for an embedded device having the above technical advantages.

### BRIEF DESCRIPTION OF THE DRAWINGS

The present application will be further explained hereinafter based on embodiments with reference to the accompanying drawings.

FIG. 1 illustrates a schematic diagram of a full update process;

FIG. 2 illustrates a schematic diagram of a compression update process;

FIG. 3 illustrates a schematic diagram of a differential update process;

FIG. 4 schematically illustrates a flow chart of a specific implementation of a firmware update method for an embedded device provided in the present application;

FIG. 5 schematically illustrates a specific flow chart of the firmware update method for an embedded device provided in the present application as executed on a development end device;

FIG. 6 schematically illustrates a flow chart of a specific implementation of a data receiving module in the firmware update method for an embedded device provided in the present application;

FIG. 7 schematically illustrates a flow chart of an implementation of the running of a bootloader program provided in the present application;

FIG. 8 is a schematic diagram illustrating the division of storage space of an embedded device when three update modes are enabled;

FIG. 9 is a schematic diagram illustrating the division of storage space of the embedded device when only full update and compression update are enabled;

FIG. 10 schematically illustrates a structural block diagram of an embedded device provided in the present application;

FIG. 11 schematically illustrates a structural block diagram of a development end device provided in the present application;

FIG. 12 schematically illustrates a structural block diagram of a firmware update system for an embedded device provided in the present application.

### DETAILED DESCRIPTION OF THE PREFERRED EMBODIMENTS

The method, device and system of the present application will be described in detail below in combination with the accompanying drawings and specific implementations. It is appreciated that the embodiments shown in the accompanying drawings and described below are merely illustrative and not intended to limit the present application.

According to the processing of transmission data in firmware updates, firmware update methods can be divided into three types: full update, compressed update, and differential update, among which differential update can also be referred to as incremental update.

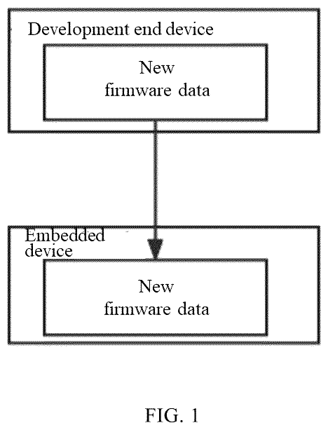

FIG. 1 shows the schematic diagram of the full update process, the full update refers to transmitting complete new firmware data to the embedded device to accomplish the firmware update.

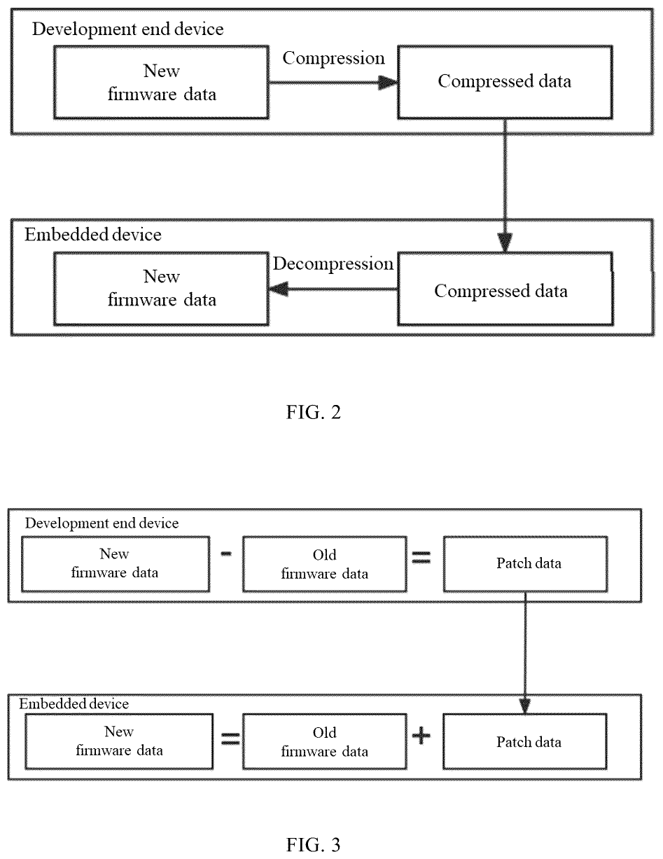

FIG. 2 shows the schematic diagram of a compression update process, the new firmware data are compressed at the development end device, the embedded device performs a decompression operation after receiving the compressed data, and then applies the decompressed new firmware data to accomplish the firmware update.

FIG. 3 shows the schematic diagram of a differential update process, differential processing is performed on the new firmware data and the old firmware data at the development end device to generate patch data, and transmits the patch data to the embedded device; the embedded device combines the received old firmware data and patch data, and performs a differential decoding operation to restore the new firmware data to accomplish the firmware update.

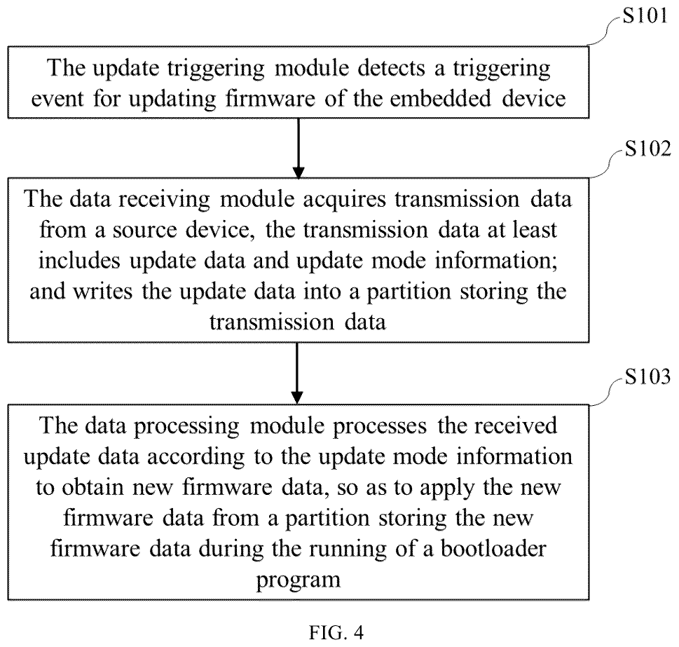

FIG. 4 shows a flow chart of a specific implementation of the firmware update method for an embedded device provided in the present application. Referring to FIG. 4, the present method is applied to an embedded device, and the embedded device includes a bootloader program and a firmware update acquisition program. The bootloader program is stored in a bootloader partition, and the firmware update acquisition program is stored in a corresponding firmware partition. The firmware update acquisition program includes an update triggering module and a data receiving module, and the bootloader program includes a data processing module.

A FOTA-enabled device usually has two types of programs: a bootloader program and a firmware program (app program). When executing the FOTA function, the bootloader program mainly accomplishes the function of reading system parameters and loading the specified firmware update acquisition program according to the system parameters. The firmware program is responsible for the normal functioning of the device and has a firmware update acquisition program integrated therein. In the present application, the data processing module may be set to be executed in the bootloader program. The update triggering module and the data receiving module may be set to be executed in the firmware update acquisition program, and are mainly responsible for receiving update data and rewriting system parameters.

The method specifically includes the following steps:

Step S101: the update triggering module detects a triggering event for updating firmware of the embedded device.

Detecting a triggering event for updating firmware of the embedded device may be specifically: the update triggering module receives a push message sent by the source device indicating that there is an updated version of the firmware; or the update triggering module sends a query request to the source device as to whether there is an updated version of the firmware, and receives a reply message from the source device indicating that there is an updated version.

Step S102: the data receiving module acquires transmission data from a source device, the transmission data at least includes update data for firmware update of the embedded device and update mode information identifying the update mode adopted for the firmware this time; and writes the update data into a partition storing the transmission data.

The transmission data at least includes update data for firmware update of the embedded device and update mode information identifying the update mode adopted for the firmware this time. It is appreciated that the transmission data may further include other data, for example, it may include any one or any combination of the following information: file header information, signature information of update data, encryption type information for encrypting the update data, file format version information, version information of update data, verification information on whether the data has been encapsulated, compression algorithm information, differential update algorithm information, length information of update data, integrity verification parameter information, signature information, version verification information or digest verification information, which does not affect the implementation of the present application.

Specifically, when the update mode information identifies that the update mode adopted for the firmware this time is differential update, the update data is patch data; when the update mode information identifies that the update mode adopted for the firmware is compression update, the update data is compressed data. When the update mode information identifies that the update mode adopted for the firmware this time is full update, the update data is new firmware data.

After the data receiving module acquires the transmission data, it writes the update data into the partition storing the transmission data.

Step S103: the data processing module processes the received update data according to the update mode information to obtain new firmware data, so as to apply the new firmware data from a partition storing the new firmware data during the running of a bootloader program.

Specifically, when the update mode information identifies that the update mode adopted for the firmware this time is differential update, the data processing module performs differential decoding on the received patch data and the old firmware data to obtain new firmware data. After the data processing module processing the received update data to obtain new firmware data, the method further includes: the data processing module writes the new firmware data into a partition storing the new firmware data, and sets the partition storing the new firmware data as a to-be-booted partition, so as to apply the new firmware data from the to-be-booted partition during the running of the bootloader program.

As a specific implementation, before the data processing module performing differential decoding on the received patch data and the old firmware data to obtain new firmware data, the method further includes: the data processing module acquires version verification information or digest verification information of the old firmware data from the transmission data; determines whether the patch data matches the old firmware data according to the version verification information or the digest verification information; if yes, performs the operation of performing differential decoding on the received patch data and the old firmware data to obtain new firmware data.

In the actual update process, the patch data generated by the firmware difference between version 3 and version 2 may be sent to an embedded device running version 1, resulting in differential decoding of the patch data and version 1, generating an erroneous version 3. Therefore, matching the patch data and the old firmware data using the above specific implementation can ensure that new firmware data can be restored only under the condition of successful matching of the patch data and the old firmware data, thereby avoiding the probability of generating new firmware data of an erroneous version and improving the reliability of the firmware update process.

When the update mode information identifies that the update mode adopted for the firmware this time is compression update, the data processing module decompresses the compressed data to obtain new firmware data. After the data processing module processing the received update data to obtain new firmware data, the method further includes: the data processing module writes the new firmware data into a partition storing the new firmware data, and sets the partition storing the new firmware data as a to-be-booted partition, so as to apply the new firmware data from the to-be-booted partition during the running of the bootloader program.

When the update mode information identifies that the update mode adopted for the firmware this time is full update, the update data is the new firmware data, and the partition storing the transmission data is the partition storing the new firmware data.

In many existing solutions, the update triggering module, the data receiving module, and the data processing module are all uniformly provided in the firmware program, thus resulting in a relatively bulky firmware program. In the solution provided in the present application, the data processing module is provided in the bootloader program. Taking an embedded device including a bootloader program and two firmware programs (app_0, app_1) as an example, Table 1 shows a comparison of the memory space required for the final FOTA function of the existing solution and the solution provided in the present application.

TABLE 1

| Solution | | Storage space required for |
|---|---|---|
| name | Function distribution | the final FOTA function |
| Existing | Both app_0 and app_1 have an update | 2 * (update triggering |
| solution | triggering module, a data receiving | module + data receiving |
| | module, and a data processing module. | module + data processing |
| | | module) |
| Solution | The data processing module is | 2 * (update triggering |
| provided in | integrated into the bootloader program. | module + data receiving |
| the present | Only the update triggering module and | module) + data processing |
| application | the data receiving module are | module |
| | integrated in app_0 and app_1 | |

As can be seen from Table 1, compared with the existing solution, the solution provided in the present application stores the data processing module in the bootloader program, which can make the entire FOTA function require less storage space.

In addition, each module will occupy a certain amount of memory when running, resulting in less available memory for the data processing module that implements decompression and decoding. Taking a network camera as an example, the RAM size thereof is 400 KB, and the available memory in the bootloader program and the firmware program is shown in Table 2.

TABLE 2

| Program | | Memory available |
|---|---|---|
| name | Main function | for FOTA |
| Bootloader | Initializing hardware and loading | 360 KB |
| program | specified firmware | |
| Firmware | Running operating system, network | <180 KB |
| program | protocol stack, camera initialization | |
| | program, and user applications | |

It can be seen that the data processing module in the present application is executed in the bootloader program, and since the bootloader program does not need to load many operating system functions nor does it need a protocol stack for network communication, the bootloader program has more available memory, which may provide more available memory space for the data processing module. For the compression update and the differential update, more available memory space means that higher-level compression algorithms may be used to perform compression, which results in smaller compressed packages or patch files, avoids excessive traffic consumption and time consumption, may be deployed on devices with limited software and hardware resources and improves the efficiency of firmware updates. In addition, compared with the existing solution that can only support one firmware update method, the present application has better compatibility and can adopt different update methods to apply to different usage scenarios and IoT devices with different functions, and to satisfy different firmware update needs.

The firmware update method for an embedded device provided in the present application may generate transmission data on the development end device. The generated transmission data may be sent directly to the embedded device for firmware update. It may also be sent to other source devices for storage, and the embedded device acquires the transmission data from the source device for firmware update.

As a specific implementation, the file format of the transmission data may be as shown in Table 3.

TABLE 3

| Serial | | |
|---|---|---|
| number | Name | Illustration |
| 0 | Magic num | Configured to verify whether the current file is |
| | | an encapsulated file |
| 1 | File format version | Configured to record the version of file format |
| | information | to facilitate file format iteration |
| 2 | Update mode | Optional values: full update, compressed |
| | information | update, and differential update |
| 3 | Compression algorithm | The compression algorithm used for |
| | information | compression update |
| 4 | Differential update | The differential algorithm used for differential |
| | algorithm information | update |
| 5 | Encryption type | The encryption algorithm used to encrypt the |
| | information | update data (sequence number 10) |
| 6 | Version information of | Version number of new firmware |
| | update data | |
| 7 | Firmware data | Recording the length of the updated data |
| | length/length of | |
| | compressed | |
| | firmware/patch file | |
| | length | |
| 8 | Firmware data | The verification data may be generated using |
| | length/length of | CRC, MD5, SHA256, and other integrity |
| | compressed | verification algorithms supported by other |
| | firmware/integrity | devices. |
| | verification parameter | |
| | information of patch file | |
| 9 | Checksum of file header | The verification data may be generated using |
| | (checksum of the above | CRC, MD5, SHA256, and other integrity |
| | content) | verification algorithms supported by other |
| | | devices. |
| 10 | Update data | Actual new firmware data, compressed data, |
| | | patch data |
| 11 | Signature Data | If signature verification is required for the |
| | | updated data, signature verification data may |
| | | also be added |
| 12 | Others | |

In Table 3, serial numbers 0 to 9 are the file headers of the transmission data generated by the development end device. The part corresponding to serial number 10 is the updated data. When the update mode information is differential update, the generated update data is patch data; when the update mode information is compressed update, the generated update data is compressed data; and when the update mode information is full update, the generated update data is new firmware data.

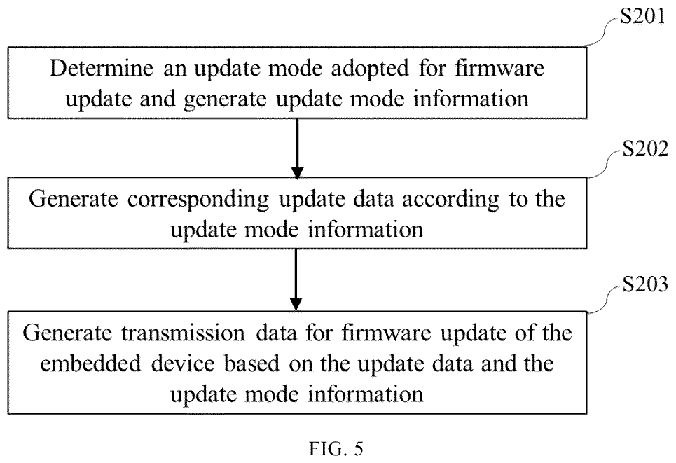

On the development end device, the specified transmission data may be generated through configuration items. Specifically, referring to FIG. 5, the specific process of the firmware update method for an embedded device provided in the present application executed on the development end device includes:

Step S201: determine an update mode adopted for firmware update and generate update mode information.

In this step, developers may select an update mode adopted for this update based on the situation of this update. Specifically, developers may first locally verify the amount of data to be transmitted for the three update modes, determine the time required for firmware update of the device, and then select the most suitable firmware update mode after comparison.

Step S202: generate corresponding update data according to the update mode information.

When the update mode information is differential update, the generated update data is patch data; when the update mode information is compressed update, the generated update data is compressed data; when the update mode information is full update, the generated update data is new firmware data.

Step S203: generate transmission data for firmware update of the embedded device based on the update data and the update mode information.

The update data and the update mode information are combined to generate transmission data for firmware update of the embedded device. The transmission data may further include any one or any combination of the following information: file header information, signature information of update data, encryption type information for encrypting the update data, file format version information, version information of update data, verification information on whether the data has been encapsulated, compression algorithm information, differential update algorithm information, length information of update data, integrity verification parameter information, signature information, version verification information or digest verification information.

Specifically, the file header part may be supplemented in the generated update data. As a specific implementation, the file header part may include the information listed in serial numbers 0 to 9 in Table 3. Furthermore, if signature information is to be used, the signature information of the update data may be added after the data is updated. If encryption function is to be used, encryption may be performed on the update data.

After the generating transmission data for firmware update of the embedded device based on the update data and the update mode information, the method further comprises: sending the transmission data to a source device for storage. The embedded device may communicate with the source device and acquire the transmission data sent by the source device for firmware update.

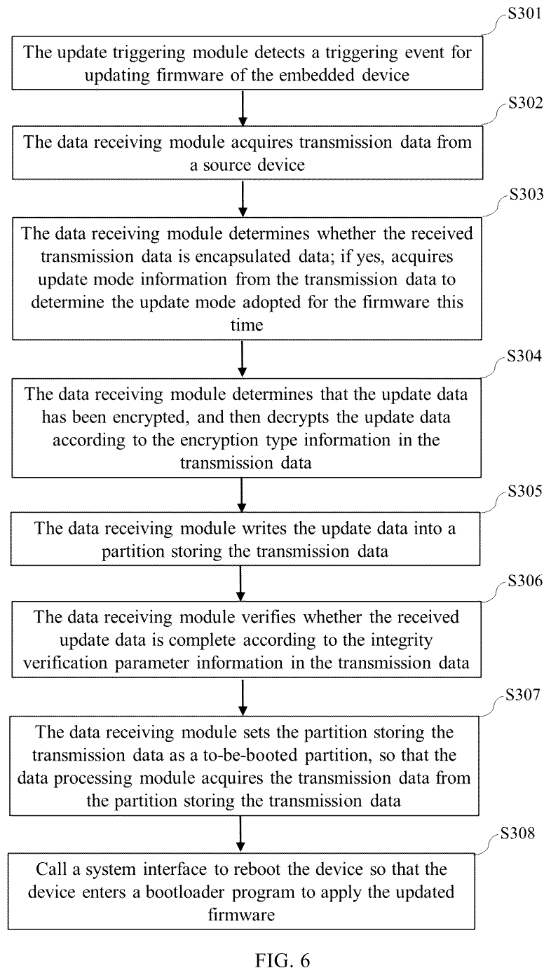

FIG. 6 illustrates a flow chart of a specific implementation of a data receiving module in the firmware update method for an embedded device provided in the present application. The method is applied to an embedded device. FIG. 6 illustrates a specific process of the embedded device receiving update data, which specifically includes:

Step S301: the update triggering module detects a triggering event for updating firmware of the embedded device.

Step S302: the data receiving module acquires transmission data from a source device.

In addition to the update data for firmware update of the embedded device and the update mode information identifying the update mode adopted for the firmware this time, the transmission data may further include the following information: file header information, signature information of update data, encryption type information for encrypting the update data, file format version information, version information of update data, verification information on whether the data is encapsulated, compression algorithm information, differential update algorithm information, length information of update data, integrity verification parameter information, signature information, version verification information or digest verification information.

The transmission data may be generated by a development end device, and the data receiving module directly acquires the transmission data from the development end device. The transmission data may also be generated by the development end device and sent to other source devices, such as a cloud device. The data receiving module acquires the transmission data from the source device, which does not affect the implementation of the present application.

Step S303: the data receiving module determines whether the received transmission data is encapsulated data; if yes, acquires update mode information from the transmission data to determine the update mode adopted for the firmware this time.

Specifically, the data receiving module determines whether the received transmission data is encapsulated data according to information in the transmission data, such as the Magic num information in Table 3. If yes, acquires the update mode information from the transmission data to determine the update mode adopted for the firmware this time.

Step S304: the data receiving module determines that the update data has been encrypted, and then decrypts the update data according to the encryption type information in the transmission data.

Specifically, the data receiving module may determine whether the update data has been encrypted. In the case where encryption has been performed, the update data is decrypted accordingly according to the encryption type information in the transmission data.

It is appreciated that in the solution provided in the present application, when the encryption and decryption functions are enabled, the decryption process thereof is executed in the firmware program which is a multi-tasking environment, and thus it is possible to perform other tasks while decrypting. Compared with the solution of executing the decryption function in the bootloader program, wherein it is impossible to perform other tasks while decrypting as the bootloader program is a single-task environment, this implementation may improve the efficiency of firmware updates.

The decryption process may specifically be performing decryption while downloading, for example, receiving 100 KB of update data, that is, decrypting the received 100 KB of update data. Of course, the decryption operation may also be performed after all the update data are received, which does not affect the implementation of the present application.

Step S305: the data receiving module writes the update data into a partition storing the transmission data.

The data receiving module writes the updated data into a partition storing the transmission data according to the update mode information. As a specific implementation, if the update mode information is full update, the update data is written into a firmware partition; if the update method is compressed update, the update data is written into the firmware partition or a pre-divided compressed partition; if the update method is differential update, the update data is written into a pre-divided patch partition.

Step S306: the data receiving module verifies whether the received update data is complete according to the integrity verification parameter information in the transmission data.

After the update data is received at step S305, the received update data is verified for integrity according to the integrity verification parameter information in the transmission data, such as serial numbers 8 and 9 in Table 3. For example, the file header checksum in the received update data is compared with the checksum calculated by the embedded device, and if they are consistent, the data is complete. If the verification passes, proceed to the next step. If the verification fails, an error message is generated and reported.

Step S307: the data receiving module sets the partition storing the transmission data as a to-be-booted partition, so that the data processing module acquires the transmission data from the partition storing the transmission data.

By rewriting the system parameters for FOTA upgrade, the partition storing the transmission data is set as a to-be-booted partition. It is appreciated that if the current update mode is compression update, the partition for storing decompressed data is specified in the system parameters; if the current update mode is differential update, the partition for storing old firmware data and the partition for storing new firmware data are specified in the system parameters.

In the above example, the embedded device has two firmware partitions app_0 and app_1. When app_0 is currently running, update data may only be written into the other idle partition app_1.

The embedded device may also have more than two firmware partitions, for example, taking the example of having three firmware partitions: app_0\app_1\app_2. In the case of a plurality of firmware partitions, assuming that the compressed firmware is downloaded to app_2 (the firmware partition with the largest serial number is generally set as the one storing the compressed firmware), the compressed firmware may be decompressed to app_0 or app_1. At this time, it is necessary to specify in the system parameters to inform the bootloader program into which partition the decompressed data is to be written.

For the case where the embedded device has dual systems, for example, app_0 is configured to store system A, and app_1 is configured to store system B, then the compressed firmware thereof may be stored in app_2, and then the data in app_2 may be decompressed by the bootloader program, and the firmware of app_0 or app_1 is updated respectively.

Step S308: call a system interface to reboot the device so that the device enters a bootloader program to apply the updated firmware.

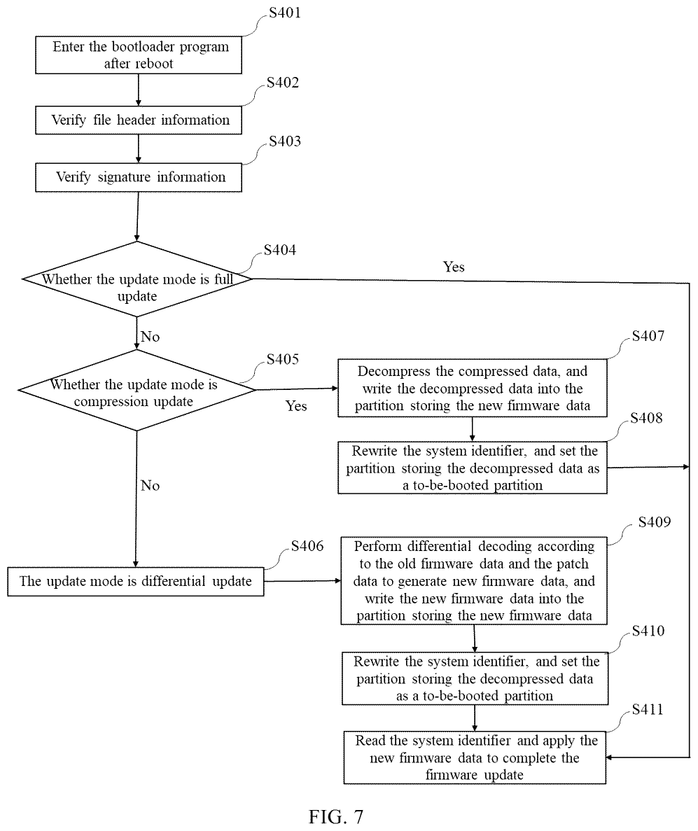

The specific operations performed during the running of bootloader program are described in further detail below. FIG. 7 shows the flow chart of an implementation of the running of a bootloader program provided in the present application, the process specifically includes:

Step S401: the embedded device enters the bootloader program after reboot.

Step S402: the data processing module acquires file header information from the transmission data and verifies the file header information.

Specifically, the data processing module may verify the file header information.

Step S403: the data processing module acquires signature information of update data from the transmission data, and verifies the signature information.

Optionally, if the function of digital signature is enabled, the bootloader program will also verify the signature information of update data to avoid the use of unauthorized data and improve the security of the system.

Step S404: the data processing module determines whether the update mode is full update, and if yes, proceeds to S411; if no, proceeds to S405;

Step S405: the data processing module determines whether the update mode is compression update, and if yes, proceeds to S407; if no, proceeds to S406;

Step S406: the data processing module determines that the update mode is differential update, and proceeds to S409;

Step S407: the data processing module decompresses the compressed data to generate decompressed data, and writes the decompressed data into the partition storing the new firmware data, and then proceeds to S408;

When the update mode is compression update, the information of the compression partition storing the compressed data is acquired by reading the system parameters, and the corresponding decompression algorithm is initialized to decompress the compressed data and write the decompressed data into the specified partition storing the decompressed data.

Step S408: rewrite the system identifier, and set the partition storing the decompressed data as a to-be-booted partition; proceed to S411;

Step S409: the data processing module performs differential decoding according to the old firmware data and the patch data to generate new firmware data, and writes the new firmware data into the partition storing the new firmware data, and then proceeds to S410;

When the update mode is differential update, the information of the partition storing the old firmware data and the information of the partition storing the new firmware data are acquired by reading the system parameters, and the corresponding differential update algorithm is initialized. Read the old firmware data and the patch data, run the differential update algorithm, and generate new firmware data. The obtained new firmware data is written into the partition storing the new firmware data.

Step S410: rewrite the system identifier, and set the partition storing the new firmware data as a to-be-booted partition; proceed to S411;

Step S411: read the system identifier and apply the new firmware data to accomplish the firmware update.

In this embodiment, when the update mode information identifies that the update mode adopted for the firmware this time is differential update or compression update, the data processing module may also acquire integrity verification parameters from the transmission data to verify whether the data written into the partition storing the new firmware data is complete. If the integrity verification passes, the data processing module preforms the operation of setting the partition storing the new firmware data as a to-be-booted partition; if the integrity verification fails, the data processing module does not perform the operation of setting the partition storing the new firmware data as a to-be-booted partition. With this setup, when there is an error in the data processing module or the device is powered off, the old firmware data and system parameters will not be destroyed, and the next attempt will continue for decompression and decoding, ensuring that the received new firmware data is complete data, avoiding loading incomplete new firmware which causes abnormal device startup, thereby improving the reliability of the system. In addition, when the update mode adopted is compression update, after performing operations such as decompression or transfer, the present application will not erase the data, but will only rewrite the system identifier after successful decompression, avoiding the erasing operation to increase the runtime of the bootloader, thus making the startup time of the present application faster, and avoiding the risk that the device can only be restored to factory settings due to no runnable apps in the event of a failed reboot.

It is appreciated that when the update mode is full update, the data in the current partition is the new firmware data. Therefore, when the bootloader program is executed, there is no need to transfer the data to the partition storing the new firmware data, that is, the partition currently booted normally is the partition storing the new firmware data. Therefore, there is no need to rewrite the system identifier in this step. When using ping-pong upgrade, the new firmware data is written into the partition storing the new firmware data. After rebooting, the new firmware data in the partition is directly run without transferring the data in the partition to another storage partition, which makes reboot faster and reduces the loss caused by the erase operation of the storage partition, thus prolonging the service life of the storage device.

Existing solutions often only support one firmware update mode, with poor compatibility, cannot be applied to different usage scenarios, and cannot meet the needs of updating IoT devices with different functions. The firmware update method provided in the present application is compatible with three update modes: differential update, compressed update, and full update, and may meet the firmware update needs of different devices. Furthermore, the problem of unstable size of patch data of differential update and compressed data of compressed update may be solved. In case the patch partition is too large, that is, there is a lot of content involved in this update, resulting in the actual size of the patch data exceeding the pre-divided patch partition or compressed partition, the purpose of saving traffic may be achieved by compressing the update. In addition, the present application adopts a common set of file formats involving multiple verification operations such as data encryption, integrity verification, and signature verification, making the process of firmware update more secure and reliable.

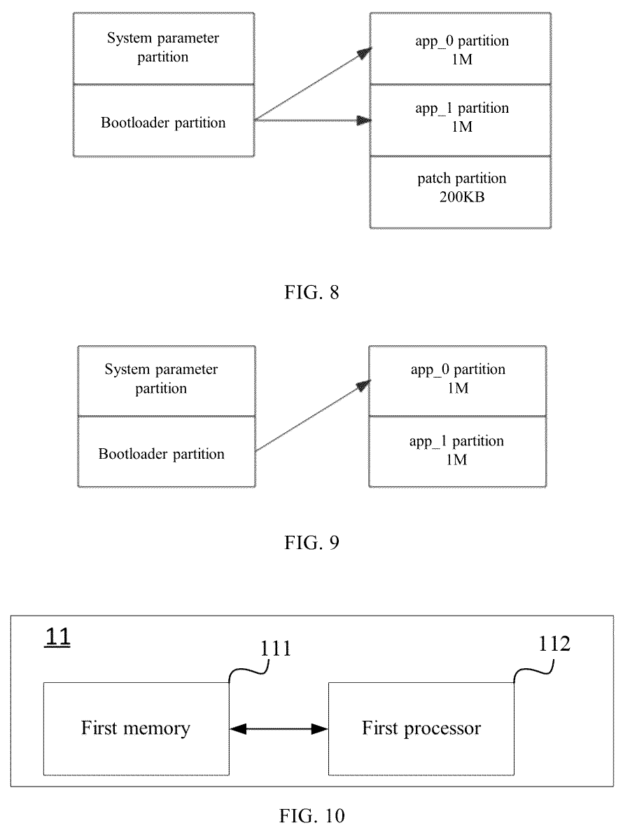

As a specific implementation, developers may decide which firmware update mode to adopt during the product design phase. The division of storage space of an embedded device that enables three update modes simultaneously may be shown in FIG. 8. The storage space may include a system parameter partition, a bootloader partition, an app_0 partition, an app_1 partition, and a patch partition. Among them, the system parameter partition is configured to store system configuration, network connection information, system boot parameters and other information. The bootloader partition is configured to store the bootloader program and load app_0 and app_1. The app_0 partition and the app_1 partition are configured to store app_0 and app_1, respectively to implement the same or different firmware functions. The patch partition is configured to store patch data when performing differential update. The firmware update method provided in the present application may be selected according to the following scenarios:

When the difference between the new firmware data and the old firmware data is small, the patch partition is sufficient to store the patch data, and thus the differential update may be used to perform this update. If the currently running app is stored in the app_0 partition, the patch data is received and then the patch partition is set as the boot partition. After reboot, the bootloader program detects the patch data in the patch partition, performs differential decoding on app_0 and the patch data, and writes the obtained new firmware data into app_1. This will not destroy the available firmware in app_0, which may otherwise cause the device to be downgraded in case of emergencies. Finally, app_1 is set as the to-be-booted partition and the new firmware data in app_1 is applied. Similarly, if app1 is currently running, the patch data is received in app_1, and then a differential decoding operation between app_1 and the patch data is performed.

It is appreciated that most of the current differential update algorithms such as vcdiff, bsdiff, and xdelta do not support local update on the embedded device with limited software and hardware resources, and thus a separate patch partition is required to store the patch data. The differential update algorithm used in the present application may be the differential update algorithm described above and variant algorithms thereof, which does not affect the implementation of the present application.

When the difference between the new firmware data and the old firmware data is large, the patch partition may not be able to store the patch data. Previous solutions chose to use multiple differential updates, updating only a part each time to eventually accomplish all the updates. However, in the scenario of major changes (e.g., the purchased device has not been upgraded and needs to be upgraded from version 1 to version 10), it will affect the customer experience. At this point, compression update may be used. If the currently running app is stored in the app_0 partition, download the compressed file to the app_1 partition, and then set app_1 as the to-be-booted partition. After reboot, the bootloader program may immediately find the partition where the compressed data is located, and then find that there is a compression update to be accomplished. Then, in the bootloader program, decompress the compressed firmware in the app_1 partition to the app_0 partition. After decompression, rewrite the boot partition to app_0 and apply the new firmware data in the app_0 partition.

Differential update and compressed update may save transmission traffic, reduce the parallel pressure on the source device that sends update data, and save time for transmitting update data. However, both the differential update and compressed update need to be decompressed or decoded in the bootloader program, which will affect the quick startup of the bootloader program. For devices that require quick startup (such as traffic violation capture cameras) or use LAN for update (traffic is not charged), full update mode may be adopted for update.

It is difficult for existing solutions to provide a reasonable division of storage space. When the storage space divided for storing compressed data or patch data is small, the firmware update cannot be accomplished due to insufficient physical storage space. In the present application, in cases where differential update cannot be used, for example, when the old firmware data and the new firmware data are significantly different, resulting in larger patch data being generated, it is possible to adopt compressed update or full update, so as to utilize the resources of the device to a greater extent and improve the user experience.

As a specific implementation, developers may also enable only full update and compressed update during the product design phase. At this time, the division of storage space of the embedded device may be shown in FIG. 9, and the storage space may include a system parameter partition, a bootloader partition, an app_0 partition, and an app_1 partition. Among them, the system parameter partition is configured to store system configuration, network connection information, system boot parameters and other information. The bootloader partition is configured to store the bootloader program and load app_0 and app_1. The app_0 partition and the app_1 partition are configured to store app_0 and app_1, respectively to implement the same or different firmware functions. In this scenario, the solution provided in the present application may be selected according to the following scenarios:

When there is a need to save traffic or save time on transmitting update data, compression update may be chosen for this update. If the app_0 partition is currently running, download the compressed firmware to the app_1 partition; perform decompression in the bootloader program, write the decompressed new firmware data into the app_0 partition, and then boot the new firmware data in the app_0 partition to run.

When a quick startup is required, or the network environment is good and there is no need to save traffic, this update uses full update.

Taking the currently popular xz compression algorithm and bsdiff differential update algorithm as examples, the memory consumption required for data processing on the device side at different compression rates is shown in Table 4. The higher the compression rate, the smaller the data to be transmitted, and the more memory required on the embedded device.

$$Compression rate = ( size of original data - size of patch or compressed data ) / size of original data .$$

TABLE 4

| | | Required |
|---|---|---|
| | Average compression | decompression/decoding |
| Name | rate | memory |
| xz | 45% | 59 KB |
| xz | 50% | 90 KB |
| bsdiff(bzip = 3) | 92% | 80 KB |
| bsdiff(bzip = 9) | 98% | 290 KB |

In the present application, the data processing module is executed in the bootloader program. Since the bootloader program does not need to load many operating system functions and does not need a protocol stack for network communication, the bootloader program has more available memory, which can provide more available memory space for the data processing module. For compressed update and differential update, more available memory space means that higher-level compression algorithms may be used to perform compression, which results in smaller compressed packages or patch files, avoids excessive traffic consumption and time consumption, and improves the efficiency of firmware update.

In addition, the present application further provides an embedded device 11, as shown in the structural block diagram of the embedded device provided in the present application in FIG. 10, the embedded device 11 specifically includes: a first memory 111 and a first processor 112, the first memory 111 is configured to store a computer program, and the first processor 112 is configured to implement any of the firmware update methods for an embedded device described above when executing the computer program.

It is appreciated that the process of executing firmware update by the embedded device corresponds to the firmware update method applied to the embedded device described above, which may be referred to above and will not be repeated herein.

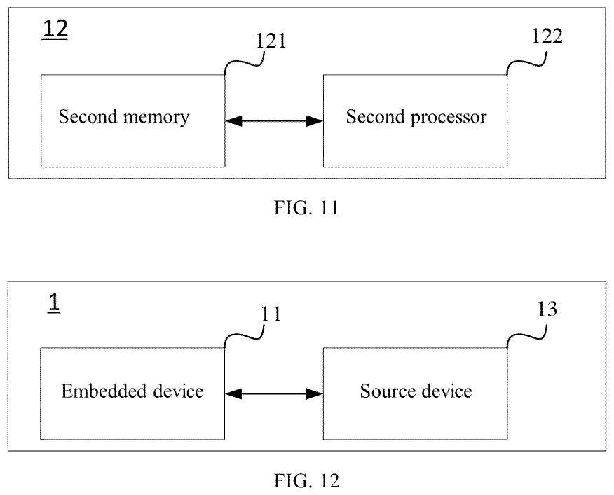

In addition, the present application further provides a development end device 12, as shown in the structural block diagram of the development end device provided in the present application in FIG. 11, the development end device 12 includes: a second memory 121 and a second processor 122, the second memory 121 is configured to store a computer program, and the second processor 122 is configured to implement any of the firmware update methods for an embedded device described above when executing the computer program.

It is appreciated that the development end device may correspond to the firmware update method applied to the development end device described above, which may be referred to above and will not be repeated herein.

In addition, the present application further provides a firmware update system for an embedded device 1, as shown in the structural block diagram of the firmware update system for an embedded device provided in the present application in FIG. 12, including an embedded device 11 and a source device 13; the source device 13 stores transmission data for firmware update of the embedded device.

The data transmission between the embedded device 11 and the source device 13 may be performed via a variety of communication protocols. The source device 13 may be a development end device or a cloud device. The embedded device 11 may adopt the firmware update method for an embedded device recorded in the present application for firmware update. The specific implementations may be referred to the description of the method content and will not be repeated herein.

While various embodiments of various aspects of the present application have been described for the purpose of this disclosure, it shall not be appreciated that the teaching of this disclosure is limited to these embodiments. The features disclosed in a specific embodiment are not limited to that embodiment, but may be combined with the features disclosed in different embodiments. For example, one or more features and/or operations of the method according to the present application described in one embodiment may also be applied alone, in combination or as a whole in another embodiment. Those skilled in the art will understand that there are more possible optional implementations and variants, and various changes and modifications may be made to the above systems without departing from the scope defined by the claims of the present application.

1. A firmware update method for an embedded device, the method being applied to the embedded device, the embedded device comprising a bootloader program and a firmware update acquisition program; the bootloader program being stored in a bootloader partition, the firmware update acquisition program being stored in a corresponding firmware partition, the firmware update acquisition program comprising an update triggering module and a data receiving module, the bootloader program comprising a data processing module, and the method comprising:
detecting, by the update triggering module, a triggering event for updating firmware of the embedded device;
acquiring, by the data receiving module, transmission data from a source device, the transmission data at least comprising update data for firmware update of the embedded device and update mode information identifying an update mode adopted for the firmware this time; and writing the update data into a partition storing the transmission data; and
processing, by the data processing module, received update data according to the update mode information to obtain new firmware data, to apply the new firmware data from a partition storing the new firmware data during running of the bootloader program.

2. The firmware update method for an embedded device according to claim 1, wherein in response to the update mode information identifying that the update mode adopted for the firmware this time is differential update, the update data is patch data.

3. The firmware update method for an embedded device according to claim 2, wherein the data processing module processing the received update data to obtain new firmware data comprises:
performing differential decoding on the received patch data and the old firmware data to obtain new firmware data;
after the data processing module processing the received update data to obtain new firmware data, the method further comprises:
writing, by the data processing module, the new firmware data into a partition storing the new firmware data, and setting the partition storing the new firmware data as a to-be-booted partition, to apply the new firmware data from the to-be-booted partition during the running of the bootloader program.

4. The firmware update method for an embedded device according to claim 3, wherein before the data processing module performing differential decoding on the received patch data and the old firmware data to obtain new firmware data, the method further comprises:
acquiring, by the data processing module, version verification information or digest verification information of the old firmware data from the transmission data, and determining whether the patch data matches the old firmware data according to the version verification information or digest verification information; and
if yes, performing the operation of performing differential decoding on the received patch data and the old firmware data to obtain new firmware data.

5. The firmware update method for an embedded device according to claim 1, wherein in response to the update mode information identifying that the update mode adopted for the firmware this time is compression update, the update data is compressed data.

6. The firmware update method for an embedded device according to claim 5, wherein the data processing module processing the received update data to obtain new firmware data comprises:
decompressing the compressed data to obtain new firmware data;
after the data processing module processing the received update data to obtain new firmware data, the method further comprises:
writing, by the data processing module, the new firmware data into a partition storing the new firmware data, and setting the partition storing the new firmware data as a to-be-booted partition, to apply the new firmware data from the to-be-booted partition during the running of the bootloader program.

7. The firmware update method for an embedded device according to claim 1, wherein in response to the update mode information identifying that the update mode adopted for the firmware this time is full update, the update data is new firmware data, and the partition storing the transmission data is the partition storing the new firmware data.

8. The firmware update method for an embedded device according to claim 1, wherein the update triggering module detecting a triggering event for updating firmware of the embedded device comprises:
the update triggering module receives a push message sent by the source device indicating that there is an updated version of the firmware; and
the update triggering module sends a query request to the source device as to whether there is an updated version of the firmware, and receives a reply message from the source device indicating that there is an updated version.

9. The firmware update method for an embedded device according to claim 1, wherein after the data receiving module acquiring transmission data from a source device, the method further comprises:
determining, by the data receiving module, whether the received transmission data is encapsulated data; if yes, acquiring update mode information from the transmission data to determine the update mode adopted for the firmware this time.

10. The firmware update method for an embedded device according to claim 1, wherein before the data receiving module writing the update data into a partition storing the transmission data, the method further comprises:
determining, by the data receiving module, whether the update data has been encrypted; if yes, decrypting the update data according to encryption type information in the transmission data.

11. The firmware update method for an embedded device according to claim 1, wherein before the data receiving module writing the update data into a partition storing the transmission data, the method further comprises:
verifying, by the data receiving module, whether the received update data is complete according to integrity verification parameter information in the transmission data.

12. The firmware update method for an embedded device according to claim 1, wherein after the data receiving module writing the update data into a partition storing the transmission data, the method further comprises:
setting, by the data receiving module, the partition storing the transmission data as a to-be-booted partition, to enable the data processing module to acquire the transmission data from the partition storing the transmission data.

13. The firmware update method for an embedded device according to claim 12, wherein before the data processing module applying the new firmware data from a partition storing the new firmware data during the running of the bootloader program, the method further comprises:
acquiring, by the data processing module, file header information from the transmission data, and verifying the file header information.

14. The firmware update method for an embedded device according to claim 12, wherein before the data processing module applying the new firmware data from a partition storing the new firmware data during the running of the bootloader program, the method further comprises:
acquiring, by the data processing module, signature information of update data from the transmission data, and verifying the signature information.

15. The firmware update method for an embedded device according to claim 12, wherein after the data processing module applying the new firmware data from a partition storing the new firmware data during the running of the bootloader program, the method further comprises:
acquiring, by the data processing module integrity verification parameter information from the transmission data, and verifying whether the data written into the partition storing the new firmware data is complete.

16. The firmware update method for an embedded device according to claim 15, wherein in response to the update mode information identifying that the update mode adopted for the firmware this time is differential update or compression update, after the data processing module acquiring integrity verification parameters from the transmission data and verifying whether the data written into the partition storing the new firmware data is complete, the method further comprises:
in response to that the integrity verification passes, preforming, by the data processing module, the operation of setting the partition storing the new firmware data as a to-be-booted partition; in response to that the integrity verification fails, not preforming, by the data processing module, the operation of setting the partition storing the new firmware data as a to-be-booted partition.

17. An embedded device comprising a first memory and a first processor, wherein the first memory is configured to store a computer program, and the first processor is configured to implement the firmware update method for an embedded device according to claim 1 when executing the computer program.

18. A firmware update method for an embedded device, the method being applied to a development end device, and comprising:
determining an update mode adopted for firmware update and generating update mode information;
generating corresponding update data according to the update mode information; and
generating transmission data for firmware update of the embedded device based on the update data and the update mode information.

19. The firmware update method for an embedded device according to claim 18, wherein generating corresponding update data according to the update mode information comprises:
in response to that the update mode information is differential update, the generated update data is patch data;
in response to that the update mode information is compression update, the generated update data is compressed data; and
in response to that the update mode information is full update, the generated update data is new firmware data.

20. (canceled)

21. The firmware update method for an embedded device according to claim 18, wherein after the generating transmission data for firmware update of the embedded device based on the update data and the update mode information, the method further comprises:
sending the transmission data to a source device for storage.

22. (canceled)

23. (canceled)

24. (canceled)
